(19) United States
(12) Patent Application Publication
(10) Pub. No.: US 2019/0225422 A1
(43) Pub. Date: Jul. 25, 2019

(54) DETECTION SYSTEM FOR A SIDE LOADING WASTE COLLECTION VEHICLE

(71) Applicant: SUPERIOR PAK HOLDINGS PTY LTD, Queensland (AU)

(72) Inventors: Robert Wrigley, Queensland (AU); Rowland Errington, Queensland (AU); Michael Pronger, Queensland (AU)

(21) Appl. No.: 16/316,370

(22) PCT Filed: Jun. 23, 2017
(86) PCT No.: PCT/AU2017/050640

§ 371 Date: Jan. 9, 2019

(30) Foreign Application Priority Data
Jul. 13, 2016 (AU) 2016902751

(51) Int. Cl. B65F 3/04; F16P 3/12; B60Q 5/00

(52) U.S. Cl. CPC B65F 3/045; B65F 2003/0276; B60Q 5/006; F16P 3/12

(57) ABSTRACT

A detection system for a side loading waste collection vehicle with a side lifting arm for lifting and lowering a bin and a gripping assembly near the end of the lifting arm, including one or more sensors to detect the presence of an object or person, control means to receive and process sensor input to control the operation of the lifting arm, wherein the detection system defines two zones where a first zone covers the space through which the bin moves between a raised and a lowered position and a second zone is the space surrounding the first zone; in use the movement of the lifting arm is stopped when a person or object is detected within the first zone and when a person or object is detected moving within the second zone.

### FIELD OF INVENTION

The present invention relates to a detection system for side loading waste collection vehicles. The present invention has particular but not exclusive application for detection of a person or object at the side of the waste collection vehicle in the operating space of the bin lifting arms. Reference in the specification will be made to waste collection vehicles that lift bins from the side of the vehicle, but the invention is not limited to this application.

### BACKGROUND OF THE INVENTION

Side loading waste collection vehicles uses a lifter arm and beam that extends, grabs a bin and lifts the bin to empty the waste into the vehicle's hopper and then return the bin to its original position. The lifter arm and beam is controlled with a joystick and buttons by the driver. The alignment of the lift arm with the rubbish bin is manually controlled by the driver and the efficiency of alignment and rubbish collection depends on the experience and skill competency of the driver.

Within a group of drivers there is a range of efficiencies in the collection of waste. The alignment and grabbing of the rubbish bin is problematic as the driver must use mirrors and cameras to judge the best position for the vehicle and how far to extend and position the lifting arm to grab the rubbish bin. The driver is required to maintain concentration while taking into consideration the different variables in order to collect the waste from the rubbish bins.

Sometimes there are other objects or people in the immediate area of the rubbish bin to be collected. This is an additional concern for the driver as they must recognize, assess and work around the additional object or person. Where there is a person standing near a rubbish bin, there is a real safety concern that the gripping arms do not grab the person. Furthermore, the problem is compounded if the person is moving near the rubbish bin as the driver must assess where they are at any single point in time.

### OBJECT OF THE INVENTION

It is an object of the present invention to reduce the complexity of the rubbish bin collection process and increase the safety of a person who is near a bin during the collection of the waste, and/or provide the consumer with a useful or commercial choice.

### SUMMARY OF THE INVENTION

The present invention was conceived and developed after considering different options to address the aforementioned problems, developing a sensor detection system and determining the optimal position of the sensors and configuring the efficient integration of the sensor detection system with the lifting and operational controls.

In one aspect, the present invention broadly resides in a detection system for the side loading waste collection vehicle with a side lifting arm for lifting and lowering a bin and a gripping assembly near the end of the lifting arm, including

one or more sensors to detect the presence of an object or person;

control means to receive and process sensor input to control the operation of the lifting arm,

wherein in use, when the presence of the object or person is detected the movement of the lifting arm is stopped.

Preferably when the lift arm is moving and an object or person is detected, the operation of the lift arm is stopped.

Preferably the one or more sensors are able to detect the object or person within a defined perimeter. More preferably the one or more sensors are able to detect the presence of the object or person and movement of the person or object within a defined area or space including the area that would be occupied by the returned bin.

The one or more sensors can be proximity sensors, motion or movement sensor or a combination of these sensors.

There is preferably an object detection sensor mounted on the body of the vehicle above the lift arm and or an object detection sensor on the lift arm preferably above the lift arm actuator. The object detection sensor mounted on the vehicle body and or the object detection sensor on the lift arm, detects the presence of an object in and around an area occupied by the bin. Preferably the detection of an object in and around an area occupied by the bin causes the movement of the lift arm to stop or not commence operation. More preferably there are predefined exceptions to the list of objects where movement of the lift arm can occur. The control means preferably analyses the input from the one or more sensors and continues movement of the lifting arm when the detected object is determined to be a predefined exception. Preferably the control means continues movement of the lifting arm when the object is determined to be a predefined exception within the first zone. Preferably the predefined exceptions include a post box, a tree, a bush, another rubbish bin adjacent to the bin, and/or other similar objects. More preferably the predefined exceptions include a post box, a tree, a bush, another rubbish bin adjacent to the bin, and/or other similar objects, when they are spaced from the bin.

There is preferably a movement sensor mounted towards the rear of the vehicle and able to detect a moving object preferably between the rear of the vehicle and the lift arm or a position forward of the lift arm. If a moving object is detected, an alarm is preferably activated and movement or operation of the lift arm remains possible.

There is preferably a second motion sensor on the vehicle near the lift arm or forward of the lift arm to detect movement of an object from the front of the vehicle to the lift arm.

More preferably the one or more motion sensors also include a proximity sensor.

In the preferred embodiment where there is a camera mounted on or adjacent to the lift arm, input from the camera can be combined and processed with the input from the sensors to provide actuation output for the lift arm and operational systems.

With input from the camera and sensors, objects are preferably determined by size and shape, bin colour and bin lid colour. Preferably input is biased in the following order beginning with the feature that is most heavily weighted: bin size and shape, bin colour and bin lid colour. Preferably the camera able to detect the size and shape of the bin, and the control means controls the operation of the lifting arm based on the size and shape of the bin. More preferably the camera is able to detect the colour of the bin or the colour of a lid of the bin, and the control means controls the operation of the lifting arm based on the colour of the bin or the lid of the bin.

In one embodiment, the detection system includes an RFID detector. Preferably the control means controls the operation of the lifting arm based on detection of an RFID tag associated with the bin.

The detection system preferably defines two zones where a first zone covers the space through which the bin moves between a raised and a lowered position and a second zone is the space surrounding the first zone. Preferably the one or more sensors are able to detect an object when it is in the first zone and provide input that is processed and provide appropriate actuation output or instructions. The lift arm will preferably stop operation if an object (other than programmed exception objects) is detected in the first zone. An alarm can also be activated when an object is detected.

Preferably surrounding the first zone is a second zone. The defined area or space surrounding the first zone preferably forms the second zone. Preferably the second zone extends around the outside of the first zone and provides a buffer zone between the outside and the first zone where objects can first be detected prior to entering the first zone.

Preferably, if a moving object is detected in the second zone, an alarm is activated but the operation of the lift arm continues. Where objects are moving rapidly in the second zone, the lifter arm and lifter beam can in some embodiments be programmed to stop operation. When an alarm is activated, the alarm can be an audible alarm, a visual alarm such as a flashing light, and or a warning indicia on the dashboard of the vehicle.

Preferably objects include pedestrians, animals, vehicles, cyclists, wind-blown objects and other similar moving objects as well as stationary objects such as a wall, tree, post box, parked car or motorbike, and or an adjacent bin.

In one embodiment, the detection system is deactivated when the bin has been returned to the ground or at a predetermined height above the ground. In one preferred embodiment, the deactivation height is below the vertical scanning height of the sensors.

The control means preferably includes a programmable logic controller and or processor to process the sensor input. In one form, the sensor input preferably provides an over-riding parameter in the control of the operation of the lift arm.

In another aspect, the invention broadly resides in a system for lifting and lowering lift arms of a side loading waste collection vehicle using a detection system as described above, including

one or more sensors to detect the presence of an object or person;

control means to receive and process sensor input to control the operation of the lift arm; and

actuation means to actuate the movement of the lift arm in response to operational signals from the control means, wherein when the presence of the object or person is detected the lifting arms are stopped.

The actuation means preferably includes one or more hydraulic pistons operationally associated with the lifter arm and being electrically controlled.

Preferably there are one or more warning signals including an audible alarm and/or flashing lights that alert the driver and others to the possibility of a problem when a person or object is detected by the one or more sensors.

In another aspect, the invention broadly resides in a vehicle with a side loading lifting arm for lifting and lowering a bin that includes a detection system as described above.

In a further aspect, the invention broadly resides in a system for lifting and lowering a lifting arm of a side loading waste collection vehicle including

one or more sensors to detect the presence of an object or person;

control means to receive and process sensor input to control the operation of the lifting arm; and

actuation means to actuate the movement of the lift arm in response to operational signals from the control means,

wherein the detection system defines two zones where a first zone covers the space through which the bin moves between a raised and a lowered position and a second zone is the space surrounding the first zone, and wherein in use the movement of the lifting arm is stopped when a person or object is detected within the first zone and when a person or object is detected moving within the second zone.

Preferably a camera is mounted on or adjacent the lifting arm, the camera able to detect the size and shape of the bin, and the control means controls the operation of the lifting arm based on the size and shape of the bin, or the colour of the bin or a lid of the bin.

Preferably there are predefined exceptions to detected objects where movement of the lifting arm can occur. Preferably the control means analyses the input from the one or more sensors and continues movement of the lifting arm when the detected object is determined to be a predefined exception.

In another aspect, the invention broadly resides in a vehicle with a side loading lifting arm for lifting and lowering a bin that includes a system for lifting and lowering a lifting arm as described above.

The features described with respect to one aspect also apply where applicable to all other aspects of the invention. Furthermore, different combinations of described features are herein described and claimed even when not expressly stated.

### BRIEF DESCRIPTION OF THE DRAWINGS

In order that the present invention can be more readily understood reference will now be made to the accompanying drawings which illustrate a preferred embodiment of the invention and wherein:

FIG. 1 is a diagrammatic view of a vehicle with a non-extended side loading lift arm;

FIG. 2 is a diagrammatic view of a vehicle with an extended side loading lift arm;

FIG. 3 is a diagrammatic view of a vehicle with an extended side loading lift arm that has grabbed and beginning to lift a bin;

FIG. 4 is a diagrammatic view of a vehicle with an extended side loading lift arm that has grabbed a bin and lifted it to the hopper;

FIG. 5 is a diagrammatic plan view of a vehicle with an extended side loading lift arm and showing second zone and first zone; and

FIG. 6 is a diagrammatic rear end view of a vehicle with an extended side loading lift arm and showing second zone and first zone.

### DETAILED DESCRIPTION OF THE PREFERRED EMBODIMENT

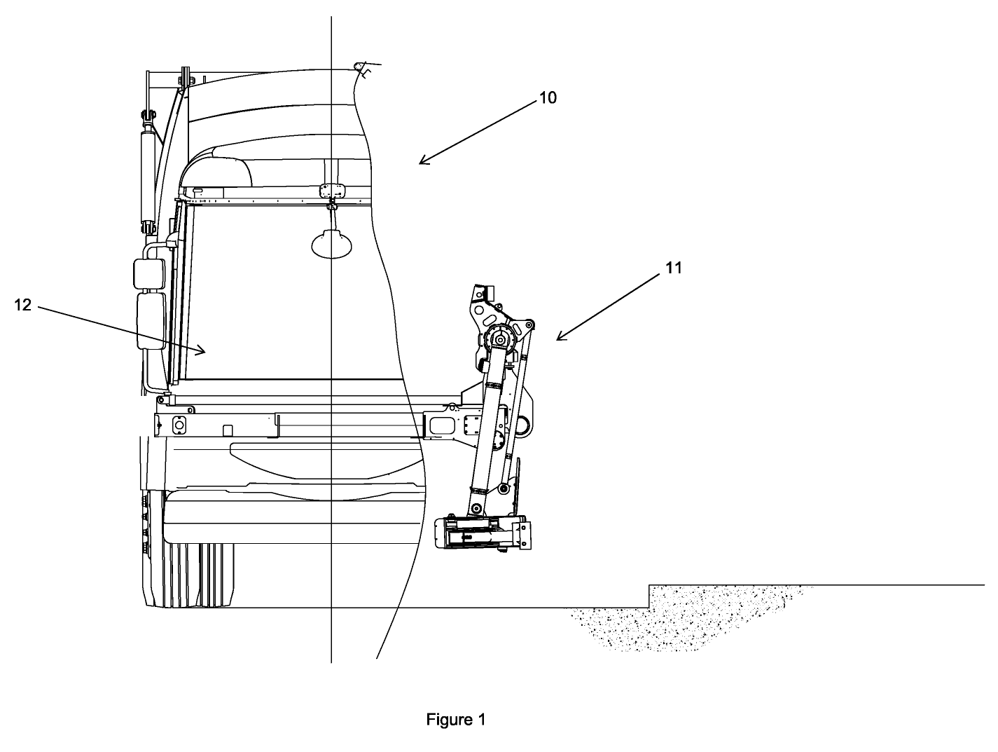

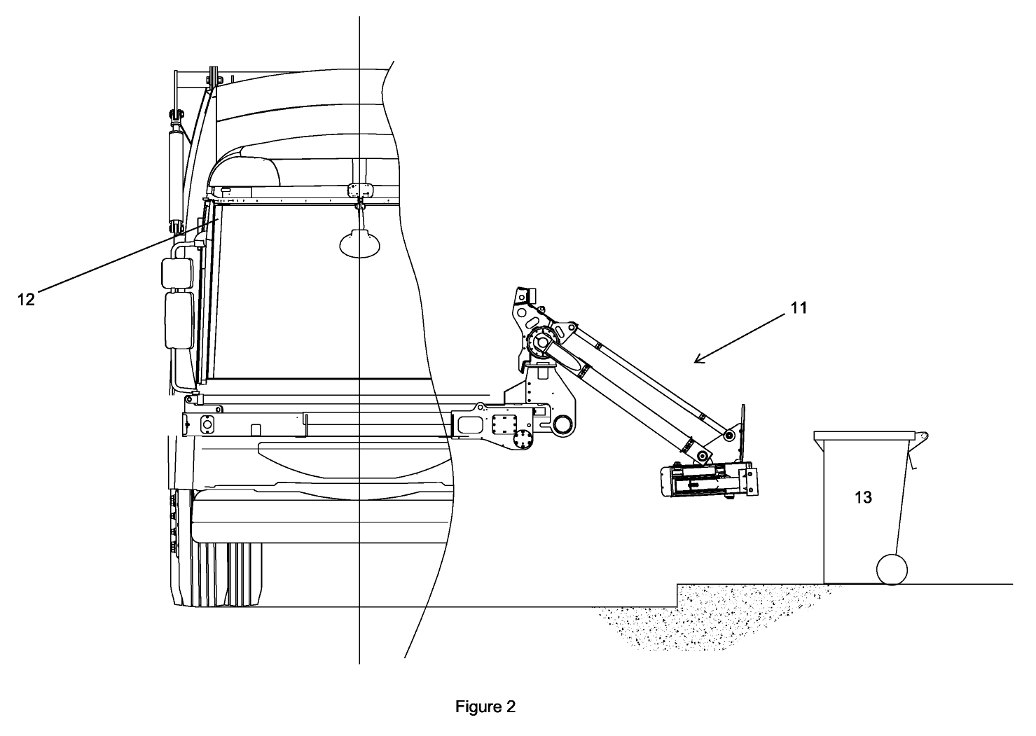

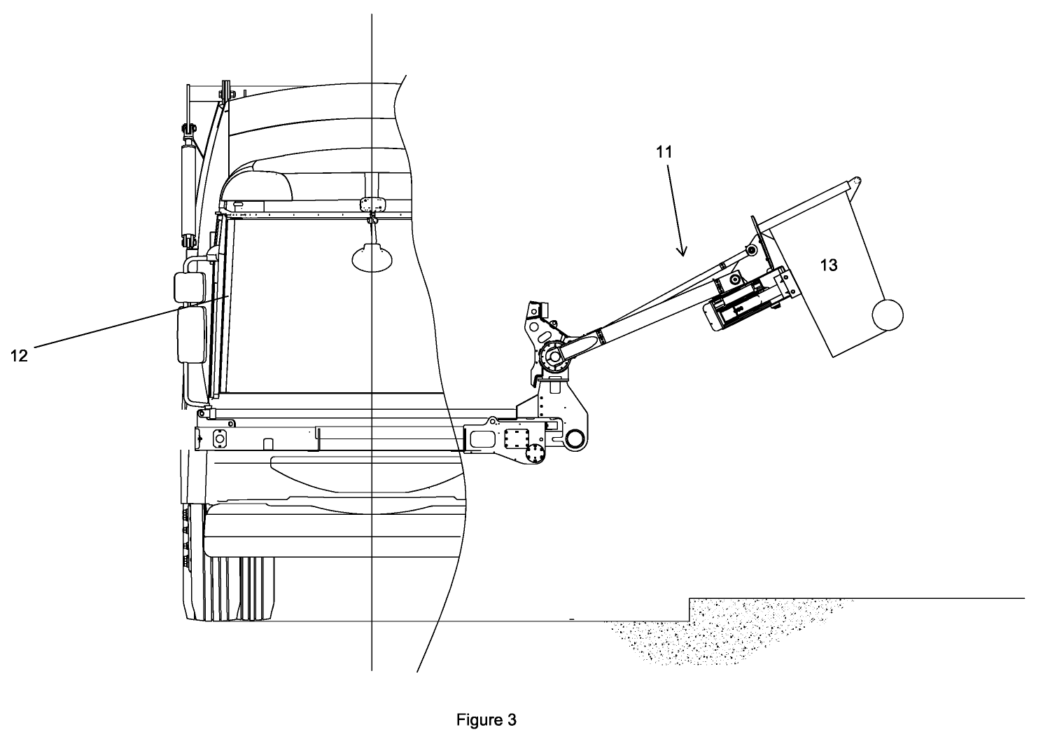

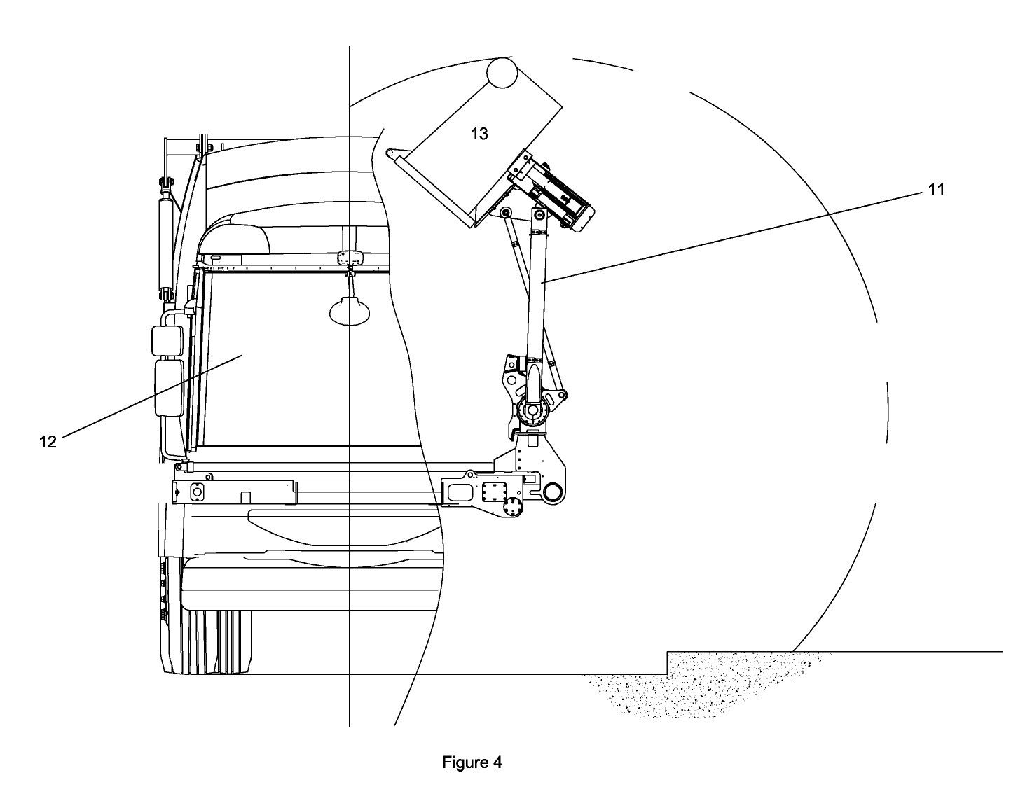

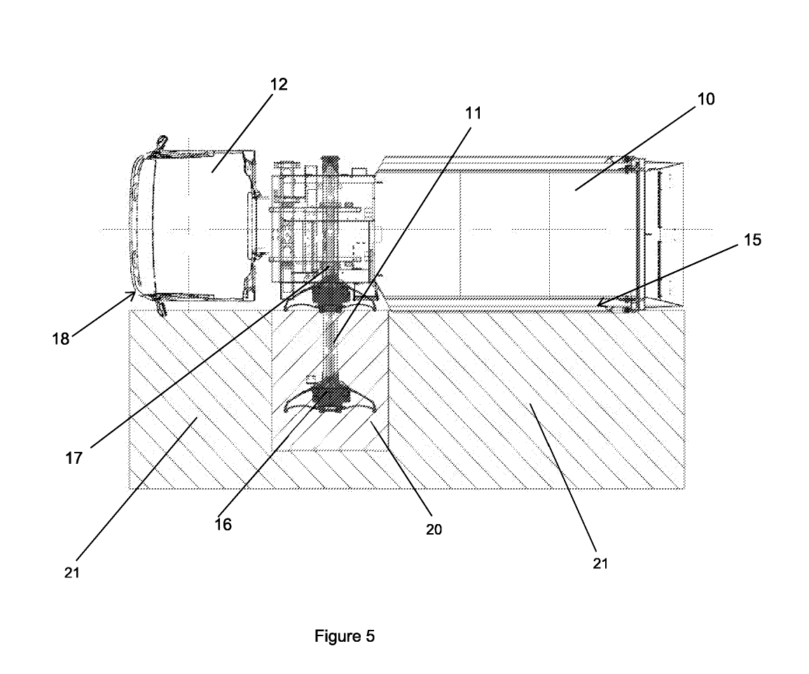

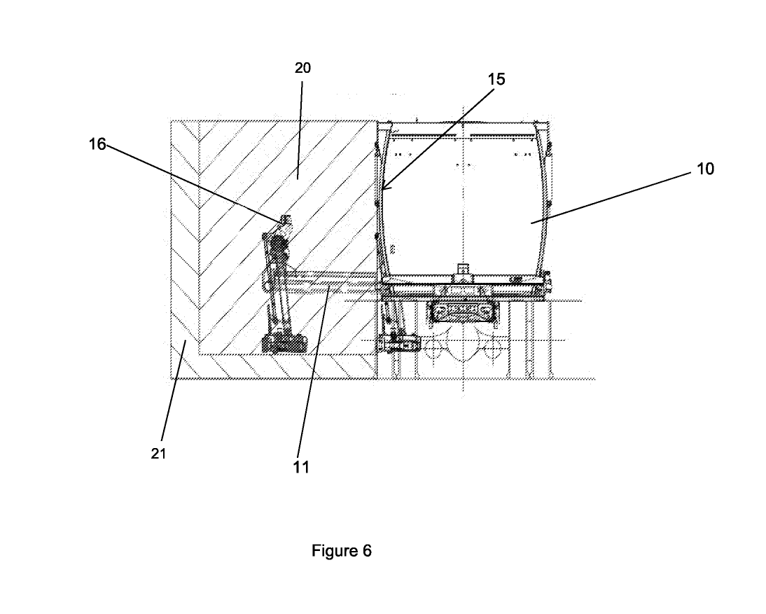

With reference to FIGS. 1 to 6, there is shown a waste collection vehicle 10 having a side loading lift arm 11. The side loading lift arm 11 extends from the side of the waste collection vehicle 10 from behind cabin 12. FIGS. 1 to 4 show the sequence of grabbing a bin 13 and lifting the bin 13 above the waste collection vehicle 10 so that the contained rubbish falls from the bin 13 into the hopper of the waste collection vehicle 10.

The side loading lift arm 11 extends from the side of the waste collection vehicle 10 to grab the bin 13. The operation of the side loading lift arm 11 is electrically controlled. The electrically controlled hydraulically actuated side loading lift arm 11 is either controlled by an automated system using a camera and sensors or manually operated by the driver within the vehicle cabin 12.

The operation of the side loading lift arm 11 is further controlled by a safety detection system that overrides the automated or manual instruction of moving the side loading lift arm 11 when an object is detected near the side loading lift arm 11.

The detection system uses input from several sensors and camera to detect the movement of the object (including persons).

There is a rear motion sensor 15 located towards the rear of the vehicle 10 and approximately 1.2 meters above the ground. There is also an object detection sensor 16 mounted on the side loading lift arm 11 and preferably above the side loading lift arm actuator. There is a camera 17 mounted on the body of the waste collection vehicle 10 above the side loading lift arm 11. There is also a front motion sensor 18 that is positioned forward of the side loading lift arm 11 and at near or on the vehicle cabin 12.

The space around the side loading lift arm 11 has been divided into two sectors where the space immediately around the side loading lift arm 11 including the space where the bin travels from the ground moving in an arc between the vehicle hopper and the ground. The space immediately around the travel space of the lift arm 11 is termed the first zone 20. The space around the first zone 20 and between the front of the vehicle cabin 12 to the rear of the vehicle is termed the second zone 21.

The sensors and camera provide input to a processor that analyses the input using predefined algorithms to provide instruction to electrically control the movement of the side loading lift arm 11. The programming detects any moving object such as a pedestrian, cyclist, windblown object or vehicle in second zone 21 and provides and activates an alarm being an audio alarm and a warning flashing light. Where the speed of the object is above a predetermined threshold, then the alarm is activated as well as the movement of the side loading lift arm 11 is stopped. If an object (whether moving or not) is detected in the second zone 21, an alarm is activated. If an object (whether moving or not) is detected in the second zone 21, the operation of the side loading lift arm 11 is stopped. The activated alarm in response to the detection of an object in the second zone 21 is, in the preferred embodiment, a different alarm that would be activated in response to a detection in the second zone 21. By way of example the alarm could be a different audio alarm and/or a different flashing warning light.

The detection system is started when the side loading lift arm 11 is aligned with the adjacent bin 13 and prior to its movement. The detection system overrides the sensor input and continues movement of the lifting arm when the bin 13 has been lowered to a predetermined level such as when the sensors can no longer provide accurate assessment of the space surrounding the side loading lift arm 11 or when the bin is returned to the ground.

The detection system is an override system primarily designed for the safety of people moving past or standing near the bin as the waste collection vehicle 10 collects the rubbish bin.

The detection system for an object or person has the advantage of preventing accidentally placing a bin on an object or causing injury to a person. The detection system of the preferred embodiment has the advantage that it can be retro-fitted to existing side loading waste collection vehicles, thereby increasing the safety to all those around the waste collection vehicle.

### Variations

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. A detection system for a side loading waste collection vehicle with a side lifting arm for lifting and lowering a bin and a gripping assembly near the end of the lifting arm, including
one or more sensors to detect the presence of an object or person;
a camera mounted on or adjacent the lifting arm, the camera able to detect the colour of the bin or the colour of a lid of the bin; and
control means to receive and process sensor input and input from the camera to control the operation of the lifting arm,
wherein the detection system defines two zones where a first zone covers the space through which the bin moves between a raised and a lowered position and a second zone is the space surrounding the first zone, and wherein in use the movement of the lifting arm is stopped when a person or object is detected within the first zone and when a person or object is detected moving within the second zone, and wherein the control means controls the operation of the lifting arm based on the colour of the bin or the lid of the bin.

2. A detection system as claimed in claim 1, wherein an alarm is activated when the presence of the object or person is detected in the second zone.

3. A detection system as claimed in claim 1, wherein the movement of the lifting arm is continued when a person or object is detected stationary in the second zone.

4. A detection system as claimed in claim 1, wherein there are predefined exceptions to detected objects where movement of the lifting arm can occur.

5. A detection system as claimed in claim 4, wherein the control means analyses the input from the one or more sensors and continues movement of the lifting arm when the detected object is determined to be a predefined exception.

6. A detection system as claimed in claim 5, wherein the control means continues movement of the lifting arm when the object is determined to be a predefined exception within the first zone.

7. A detection system as claimed in claim 5, wherein the predefined exceptions include a post box, a tree, a bush or a rubbish bin adjacent to the bin.

8. A detection system as claimed in claim 1, wherein the control means overrides the sensor input and continues movement of the lifting arm when the bin has been returned to the ground.

9. A detection system as claimed in claim 1, wherein the control means overrides the sensor input and continues movement of the lifting arm when the bin is at a predetermined height above the ground.

10. A detection system as claimed in claim 9, wherein the predetermined height is below the vertical scanning height of the sensors.

11. A detection system as claimed in claim 1, wherein one of the one or more sensors is mounted towards the rear of the waste collection vehicle and able to detect a moving object between the rear of the vehicle and the lifting arm.

12. A detection system as claimed in claim 1, wherein the camera is able to detect the size and shape of the bin, and the control means controls the operation of the lifting arm based on the size and shape of the bin.

13. (canceled)

14. A detection system for a side loading waste collection vehicle with a side lifting arm for lifting and lowering a bin and a gripping assembly near the end of the lifting arm, including
one or more sensors to detect the presence of an object or person;
a camera mounted on or adjacent the lifting arm, the camera able to detect the colour of the bin or the colour of a lid of the bin; and
control means to receive and process sensor input and input from the camera to control the operation of the lifting arm,
wherein the detection system defines two zones where a first zone covers the space through which the bin moves between a raised and a lowered position and a second zone is the space surrounding the first zone, and wherein in use the movement of the lifting arm is stopped when a person or object is detected within the first zone and an alarm is activated when the presence of the object or person is detected in the second zone, and wherein the control means controls the operation of the lifting arm based on the colour of the bin or the lid of the bin.

15. A detection system as claimed in claim 14, wherein the alarm includes a flashing light or an audible alarm.

16. A side loading waste collection vehicle having a detection system as claimed in claim 1.

17. A system for lifting and lowering a lifting arm of a side loading waste collection vehicle including
one or more sensors to detect the presence of an object or person;
a camera mounted on or adjacent the lifting arm, the camera able to detect the colour of the bin or the colour of a lid of the bin;
control means to receive and process sensor input and input from the camera to control the operation of the lifting arm; and
actuation means to actuate the movement of the lifting arm in response to operational signals from the control means,
wherein the system defines two zones where a first zone covers a space through which the bin moves between a raised and a lowered position and a second zone is a space surrounding the first zone, and wherein in use the movement of the lifting arm is stopped when a person or object is detected within the first zone and when a person or object is detected moving within the second zone, and wherein the control means controls the operation of the lifting arm based on the colour of the bin or the lid of the bin.

18. A system as claimed in claim 17, wherein the camera is able to detect the size and shape of the bin, and the control means controls the operation of the lifting arm based on the size and shape of the bin.

19. A system as claimed in claim 17, wherein there are predefined exceptions to detected objects where movement of the lifting arm can occur, and wherein the control means analyses the input from the one or more sensors and continues movement of the lifting arm when the detected object is determined to be a predefined exception.

20. A side loading waste collection vehicle having a system for lifting and lowering a lifting arm as claimed in claim 17.
